(19) United States
(12) Patent Application Publication
(10) Pub. No.: US 2009/0085719 A1
(43) Pub. Date: Apr. 2, 2009

(54) SYSTEM AND METHOD FOR MONITORING AND CONTROLLING A MOVABLE BARRIER OPERATOR UTILIZING SATELLITE COMMUNICATION CAPABILITIES

(76) Inventor: Daniel Perez, Foothill Ranch, CA (US)

Correspondence Address: JAFARI LAW GROUP, P.C., 801 N. PARKCENTER DRIVE, SUITE 220, SANTA ANA, CA, 92705, US

(21) Appl. No.: 11/864,657

(22) Filed: Sep. 28, 2007

(51) Int. Cl. G06F 7/00

(52) U.S. Cl. 340/5.7

(57) ABSTRACT

The present invention is a system and method for monitoring and controlling a movable barrier operator utilizing satellite communication capabilities. The invention comprises an access control system that utilizes a satellite link to connect a command center to one or more movable barrier operators, allowing instant monitoring, maintenance, and control of one or more movable barriers from a remote location. By configuring an access control system for telemetry communication via satellite, an exchange of information between one or more access control units, or movable barrier operators, portable remote units, or a single access unit, can be established, thus eliminating the need to physically access a movable barrier operator when service or repairs are required.

### TECHNICAL FIELD OF THE INVENTION

This invention relates generally to a system and method for monitoring and controlling a movable barrier operator utilizing satellite communication capabilities, and in particular, an access control system that utilizes a satellite link to connect a command center to one or more movable barrier operators, allowing instant monitoring, maintenance, and control of one or more movable barriers from a remote location with telemetry communication capabilities.

### BACKGROUND OF THE INVENTION

Traditionally, movable barriers, for example an automatic gate at the entrance to a given premises, utilize movable barrier operators with various functions, including means to control and adjust the parameters of the gate (i.e. the speed at which the gate opens or closes). Like any other technology, movable barrier operators require maintenance and routine adjustments to compensate, for example, for changes in the climate or regular wear and tear. Similarly, to change a desired setting for a given parameter, or upgrade a component within the operator, for example firmware, each individual unit must be physically accessed in order to make the appropriate maintenance, adjustments, or repairs.

Although this might only present an undesirable inconvenience to a consumer, for example a home owner, the problem is magnified for manufacturers, distributors, or otherwise, which are contracted by numerous customers to provide and service their movable barrier operators.

For example, a manufacturer that has sold and contracted to service thousands of units to different customers in different locations must spend time and money to provide personnel with transportation to every single location where their units, or movable barrier operators, have been installed.

This problem of inefficiency and expenditure of valuable resources is further worsened when equipment has to be returned to manufacturers for upgrading of firmware or software that is often included with such access systems. The cost of having technicians travel to a jobsite, retrieve the equipment, and return to the manufacturer is undesirable.

Similarly, manufacturers suffer losses when major upgrades due to outdated firmware must be executed and access to one or more movable barrier operators is required.

Similar problems arise when malfunctions occur in bad weather conditions or at odd hours when most business are not in operation. More expenditures and resources are required to perform any maintenance or repairs during such times. Thus, there is a need in the art for a way to communicate with access systems, for example movable barrier operators, to perform any necessary services from a remote location in order to minimize expenditure of resources.

There is a need for a system and method of accessing and communicating with movable barrier operators from a remote location; a system and method that allows for a more efficient and cost effective means of providing maintenance, adjustments, or repairs to movable barrier operators from a central command center. It is to these ends that the present invention has been developed.

### SUMMARY OF THE INVENTION

To minimize the limitations found in the prior art, and to minimize other limitations that will be apparent upon the reading of the specification, the present invention provides a system and method for monitoring and controlling a movable barrier operator utilizing a satellite communication system.

The invention comprises an access control system that utilizes a satellite link to enable communication between a command center and to one or more movable barrier operators, allowing instant monitoring, maintenance, and control of one or more movable barriers from a remote location.

A method for a command center to communicate with a movable barrier operator via a satellite system, in accordance with the present invention, comprises the steps of: connecting a module capable of telemetry communication to said movable barrier operator; receiving a first signal from said module via said satellite system to said command center; sending a second signal from said command center to said module via said satellite system; deriving a control signal from said second signal from said command center; and transmitting said control signal from said module to said movable barrier operator.

A system for communicating with a movable barrier operator utilizing a satellite system, in accordance with the present invention, comprises a module configured for telemetry communication with a command center; and a movable barrier operator connected to said module. The command center is for: receiving a first signal via said satellite system from said module; and transmitting a second signal via said satellite system to said module. The module is for: sending said first signal via said satellite system to said command center; deriving a control signal from said second signal from said command center; and transmitting said control signal to said movable barrier operator.

It is an object of this invention to provide a means of remotely communicating with an access device such as a movable barrier operator utilizing satellite communication systems.

It is another objective of this invention to provide a means of monitoring a movable barrier operator's power supply, functionality, sensor status, and various parameters from a remote location.

It is yet another objective of the present invention to provide a means of adjusting the various settings and functions of a movable barrier operator via satellite communication.

It is yet another objective of the present invention to grant access through a movable barrier operator from a remote location, utilizing satellite communication capabilities.

It is yet another objective of the present invention to provide a means of upgrading firmware or software utilized in movable barrier operators, from a remote location, via satellite communication systems.

It is yet another objective of the present invention to provide a remote command center or remote units from which to monitor and control movable barrier operators via satellite communication systems.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an illustration of the basic components for an access system for monitoring and controlling a movable barrier operator utilizing satellite communication capabilities, in accordance with one embodiment of the present invention.

FIG. 2 is a block diagram of an exemplary embodiment for an access system linked via satellite, which includes various locations from which to control and communicate with one or more movable barrier operators.

FIG. 3 is a block diagram of a module that can be incorporated with access systems in accordance with one embodiment of the present invention.

FIG. 4 is another block diagram depicting internal components of a movable barrier operator which has been modified with a module capable of telemetry communication via satellite, in accordance with another embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

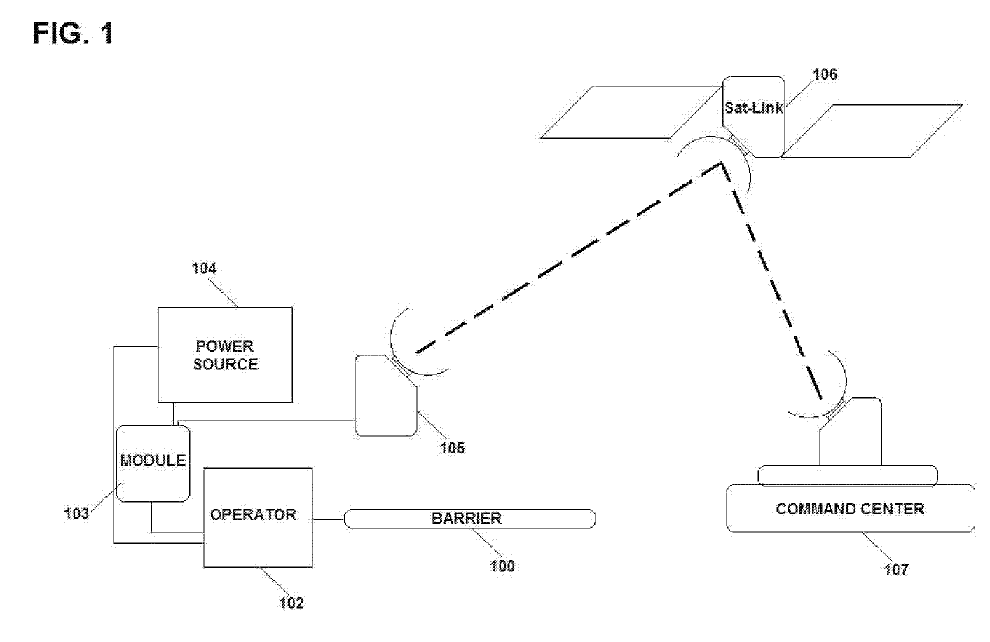

Turning first to FIG. 1, the basic components for an access system for monitoring and controlling a movable barrier operator utilizing satellite communication capabilities, in accordance with one embodiment of the present invention, is illustrated. Their functions and interrelations are explained in detail with reference to the illustration.

The system shown comprises movable barrier 100, movable barrier operator 102, module 103, power source 104, antenna 105, satellite communication device 106, and a command center 107.

A movable barrier as described in the present disclosure may be a door, a gate, a window, or any other type of device that may be manipulated to allow or prevent access to a particular area, for example an entire premises, a building, or a room. An entry way or door may be any opening, entrance or exit without deviating from the scope of the present invention. Movable barrier 100 is typically a gate to premises and is opened or closed by movable barrier operator 102.

Movable barrier operator 102 can be any type of movable barrier operator known in the art. It may open and close barrier 100 by a sliding method, a swinging method, by causing barrier 100 to roll upwards, or by any other method that grants access through barrier 100 without deviating from the scope of the present invention.

Module 103 may be any type of module configured for telemetry communication utilizing satellite capabilities without deviating from the scope of the present invention.

For example, in one embodiment, module 103 may be a satLINK Idrium™ Communication Module from Avionca. In another embodiment, module 103 may be an SRT-2100 Satellite Communication System which is lightweight and interfaces with industry standard hi-gain antenna system, from Rockwell Collins™. In yet another embodiment, module 103 is another known module directly installed or retrofitted with the internal components of movable barrier operator 102.

Power source 104 may be an electrical outlet, a battery, a generator, or any other power source known in the art capable of providing an electrical current to movable barrier operator 102 and which powers both movable barrier 102 and module 103, without departing from the scope of the present invention.

In one embodiment, power source 104 is a battery capable of providing enough power for both module 103 and movable barrier operator 102- this may be desired especially in remote areas where providing a power line may be too difficult or too costly.

In another embodiment, power source 104 comprises more than one power source such as a combination of a power supply via a power line, a generator, and a battery; such embodiment may be useful for such applications as barriers that require high security and need to be particularly protected from power failures.

Antenna 105 may be any antenna known in the art capable of sending and receiving a signal and linking module 103 with command center 107 via a communication satellite such as satellite 106.

Satellite 106 is known satellite that may be utilized to send the desired signals from command center 107 to movable barrier operator 102. Satellite 106 is a typical geostationary telecommunications satellite orbiting around 22,000 miles above ground, directly above the Earth's equator, since their constant latitude allows for antenna 105 to be easily pointed towards satellite 106 in a fixed direction to maintain a constant link. However, satellite 106 may be any other type of satellite capable of telecommunications known in the art, without deviating from the scope of the present invention.

Finally, command center 107 is where all the key functions such as maintenance, adjustments, certain repairs, and upgrades, may be performed. Typically, command center 107 is a manufacturer that has supplied a variety of customers with movable barrier operators retrofitted for telemetry communication. Command center 107 may be a single command center that controls movable barrier operator 102, or a hierarchy of multiple command centers granted with different levels of access and control to movable barrier operator 102.

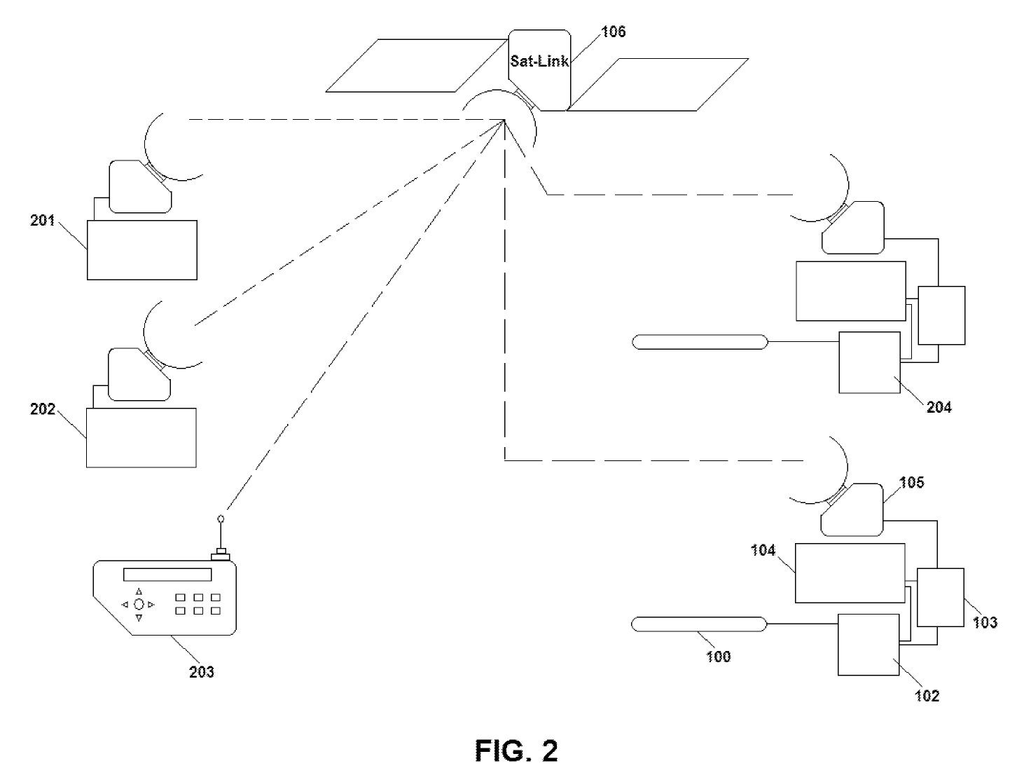

For example, and without deviating from the scope of the present invention, command center 107 comprises of a general controller station, one or more sub-stations, and one or more remote units that can monitor and control movable barrier operator 102 with different accessibility levels- such embodiment of the present invention is disclosed and described below with reference to FIG. 2.

FIG. 2 is a block diagram of an exemplary embodiment for an access system linked via satellite, which includes various locations from which to control and communicate with one or more movable barrier operators.

The different locations for a hierarchy of command center 107 may include a general controller station for a manufacturer 201, a substation for a distributor 202, and a remote control unit 203 for personnel such as a manufacturer or distributor access systems technician. These controller stations and remote control unit are linked via satellite 106 to movable barrier operator 102 and other movable barrier operators which either manufacturer 201 or distributor 202 have installed for customers.

Manufacturer 201 may have access to every bit of information made available via satellite 106 from a general controller station accessible only to said manufacturer. Manufacturer 201 may find it desirable to contract certain services to a distributor 202 so that distributor 202 may provide customers with at least some servicing (i.e. repairs or upgrades that may be under distributor warranty) thus it may be desirable to allow distributor 202 some access to the relevant component(s) of movable barrier operator 102 from a substation accessible only to distributor 202.

Although manufacturer 201 may still retain total access to movable barrier operator 102, some access is granted to distributor 202 at a substation so that distributor 202 may monitor and access movable barrier operator 102's components that distributor 202 may be in charge of (e.g. firmware).

Both distributor 202 and manufacturer 201 may have technicians to perform some duties that do require physical access to movable barrier 102 or other movable barriers 204 that are installed for customers. For example, movable barrier 102 may have been physically damaged and manufacturer 201 may send a technician to fix or replace a physical component (e.g. antenna 105). Nevertheless, since it may still be desirable to equip each technician with a device to remotely access a desired movable barrier operator, each technician may be equipped with a remote control unit 203 capable of monitoring and at least adjusting a movable barrier operator from a remote location.

For example, and without deviating from the scope of the present invention, movable barrier operator 102 may need replacement of antenna 105. After making the desired modifications or replacement of parts, it may be desirable for a technician equipped with remote control unit 203 to continue to monitor and access movable barrier 102 some time after repairs have been completed. Manufacturer 201 will still be able to have access to fully monitor and control movable barrier operator, but a technician with a remote unit 203 would retain some access and control to monitor movable barrier operator 102. This may be particularly desirable especially when is more cost effective to allow those technicians some access rather than to find a problem with movable barrier operator 102 from manufacturer 201's controller station and have to dispatch a technician multiple times.

Depending on the type of control given to a particular controller station, sub-station, or remote control unit such as remote unit 203, either manufacturer 201, distributor 202, or a technician equipped with remote unit 203, may perform a variety of monitoring functions.

In an exemplary embodiment, full control and access to movable barrier operator 102 and other movable barrier operators 204 via satellite 106, may provide access to monitor all information pertinent to each device's functionality, including: power supply status, a sensor status (including diagnostics of functions and /or malfunctions a movable barrier operator or its components may have), a motor status, and information regarding characteristics of the installation site for movable barrier operator 102 and other movable barrier operators 204, such as gate loads and voltage line changes.

Additionally, such embodiment may include monitoring capabilities for time delays settings, overlap delay settings, and obstruction sensor sensitivity- all major functions that may be desirable for movable barriers installed by either manufacturer 201 or distributor 202.

In another embodiment, an access controller or command center, such as manufacturer 201, may have a means to send information via satellite 106 and actually change a movable barrier operator's settings. For example, and without deviating from the scope of the present invention, time delays, overlap delays or obstruction sensor sensitivity may be adjusted from manufacturer 201's location or from remote unit 203.

In yet another embodiment, an access controller or command center, such as a sub-station for distributor 202, may be configured to send signals over satellite 106 and remotely control a movable barrier operator. For example, and without deviating from the scope of the present invention, distributor 202 may send a signal to movable barrier operator 102 to open or close barrier 100 in an emergency situation. Additionally, a technician equipped with remote unit 203 may desire to perform some testing or simulations to test the functionalities of barrier 100 and thus, remote unit 203 may be provided with access to send a signal via satellite 106 to movable barrier operator 102 and perform a simulation of various sensor events for purposes of troubleshooting.

In yet another embodiment, an access controller or command center, such as a controller station for manufacturer 201, a sub-station for distributor 202, or a remote unit 203, may be configured to send and receive signals via satellite 106 to upgrade firmware or software that is utilized by movable barrier operators 102 and 204. This may be performed locally for one movable barrier operator, or may be performed simultaneously to multiple movable barrier operators.

For example, and without deviating from the scope of the present invention, remote unit 203 may be utilized by an individual customer or technician to upgrade one particular movable barrier operator, such as movable barrier operator 102. Alternatively, an entire region encompassing movable barrier operator 102 and other movable barrier operators 204 may be all upgraded at once from a single location such as a controller station or command center for manufacturer 201; this may be desirable and a great advantage over sending individual technicians to different locations all over the country every time manufacturer 201 has a firmware upgrade available to customers. Depending on the type or model a customer may have, a command center or remote unit may be able to upgrade its firmware from a remote location utilizing satellite 106 all at once or individually. Thus, upgrades may be performed regionally, by country, globally, or even by type of access system a customer may have.

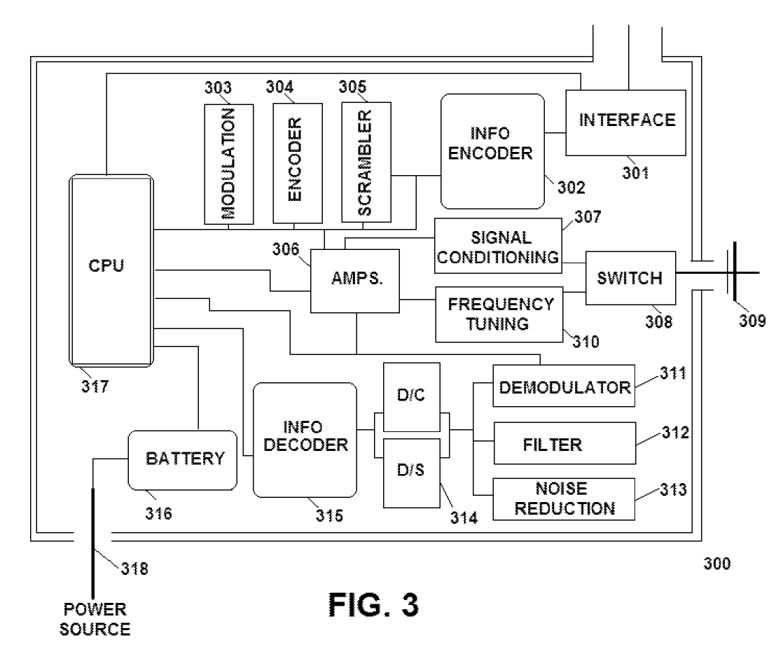

Turning to the next figure, FIG. 3 is a block diagram of a module that can be incorporated with access systems in accordance with practice of one embodiment of the present invention. These are all components presently known in the art but are disclosed for clarity and better explanation of the present invention.

A typical module comprises at least some typical components such as amplifiers, filters, a controller or CPU, an antenna, a noise reduction component, some type of decoder, a descrambler, a power source, and a movable barrier operator interface.

In the illustrated embodiment of a module in accord with the present invention, module 300 comprises of a single antenna 308 installed with a switch 309 to allow both reception and transmission capabilities. However, module 300 may have a single antenna for each function without deviating from the scope of the present invention.

Moveable barrier operator interface 301, information decoder 302 scrambler 303, encoder 304, modulator 305, amplifiers 306, signal conditioning component 307, and antenna 308 allow for module 300 to transmit signals either to a command center or a another movable barrier operator.

Frequency tuning system 310 amplifiers 306, demodulator 311, filter 312, noise cancellation 313, decoder and descrambler 314, and information decoder 314 all allow for reception capabilities; making module 300 able to receive information and relate it to a movable barrier operator. All of these components allow module 300 to link a movable barrier operator to a command center via satellite.

Module 300 has an external power source 318 which provides energy to the various components of module 300, including a back-up battery 316; this power source configuration is desired to prevent power outages from affecting module 300's performance.

Module 300 may be a separate unit, or a may be retrofitted into movable barrier operator 102; such embodiment is disclosed below.

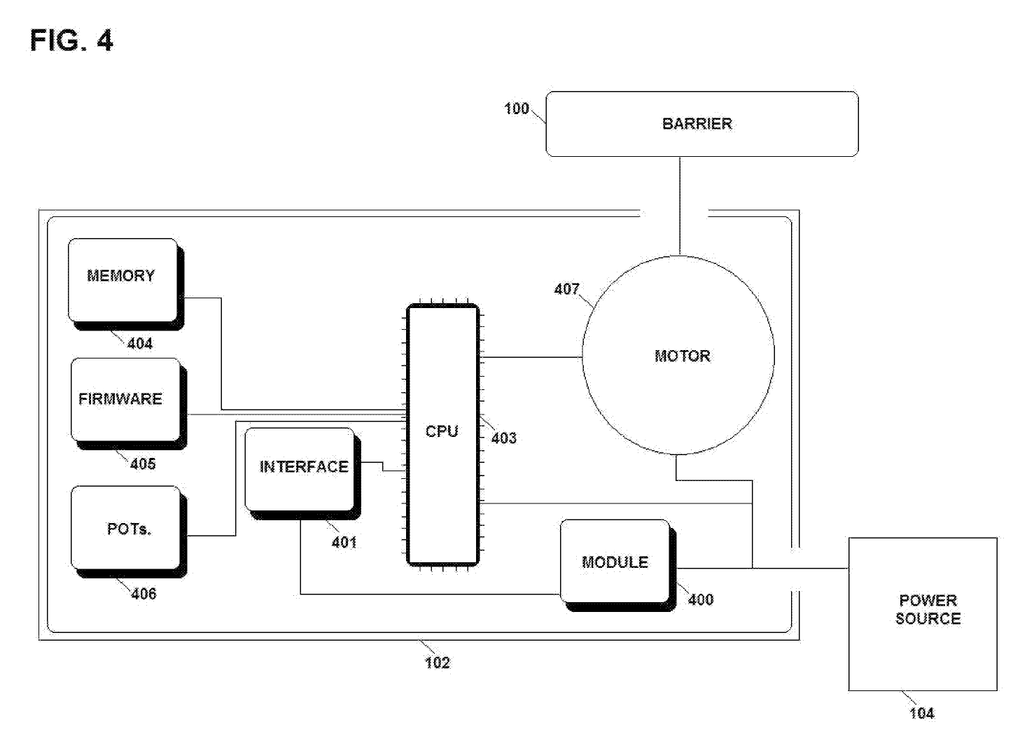

FIG. 4 is another block diagram depicting internal components of a movable barrier operator which has been modified with a module capable of telemetry communication via satellite, in accordance with another embodiment of the present invention.

Movable barrier operator 102 is shown retrofitted with a module configured for telemetry communication. Again, its components are shown in way of illustration but are all known to those skilled in the art. Aside from a module 400 and its sub-components (similar to module 300 as shown), movable barrier operator 102 comprises of module interface 401, power source 104, CPU 403, memory 404, firmware 405, potentiometers 406, and motor 405 which controls movement of barrier 100.

A system and method for monitoring and controlling a movable barrier operator utilizing satellite communication capabilities has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method for a command center to communicate with a movable barrier operator via a satellite system comprising the steps of:
connecting a module capable of telemetry communication to said movable barrier operator;
receiving a first signal from said module via said satellite system to said command center;
sending a second signal from said command center to said module via said satellite system;
deriving a control signal from said second signal from said command center; and
transmitting said control signal from said module to said movable barrier operator.

2. The method of claim 1 wherein communication with said movable barrier operator from said command center further comprises the step of monitoring a status of said movable barrier operator.

3. The method of claim 1 wherein communication with said movable barrier operator from said command center further comprises the step of adjusting a parameter of said movable barrier operator.

4. The method of claim 1 wherein communication with said movable barrier operator from said command center further comprises the step of controlling a function of said movable barrier operator.

5. The method of claim 1 wherein communication with said movable barrier operator from said command center further comprises the step of upgrading a program of said movable barrier operator.

6. The method of claim 2 wherein monitoring said status of said movable barrier operator further comprises the steps of:
checking battery power supply levels of said movable barrier operator;
sensing functionality issues arising in said movable barrier operator; and
sensing changes in weight and in voltage of said movable barrier operator.

7. The method of claim 3 wherein adjusting said parameter of said movable barrier operator further comprises the steps of changing said parameter for:
time delay to close said movable barrier;
overlap delay to open said movable barrier; and
obstruction sensor sensitivity of said movable barrier operator.

8. The method of claim 4 wherein controlling said function of said movable barrier operator further comprises the steps of:
opening said movable barrier;
closing said movable barrier;
stopping any movement of said movable barrier; and
simulating different sensor events in said movable barrier operator for troubleshooting purposes.

9. The method of claim 5 wherein upgrading said program of said movable barrier operator further comprises the step of replacing firmware of said program in order to bring said movable barrier operator up-to-date with current firmware.

10. The method as in claim 9 wherein upgrading said program of said movable barrier operator further comprises the step of replacing said program on:
an individual level;
a regional level;
a countrywide level; and
a global level.

11. The method as in claim 9 wherein upgrading said program of said movable barrier operator further comprises the step of replacing said program by:
a type of access control;
by a customer; and
by a distributor.

12. An access control system for communicating with a movable barrier operator utilizing a satellite system, comprising:
a command center for communicating via said satellite system to a module;
wherein said module is configured for telemetry communication with said command center; and
a movable barrier operator to control a movable barrier, said movable barrier operator connected to said module wherein said command center monitors a status of said movable barrier operator when said command center receives a signal sent from said module via said satellite system.

13. The system of claim 12 wherein said monitoring by said command center includes:
checking of battery power supply levels of said movable barrier operator;
sensing a plurality of functions arising in said movable barrier operator; and
sensing changes in weight and in voltage of said movable barrier operator.

14. The system of claim 12 wherein said command center is capable of adjusting a parameter of said movable barrier by sending a task signal to said module via said satellite system, and wherein said module derives a control signal from said task signal sent via said satellite system from said command center.

15. The system of claim 14 wherein said adjusting by said command center includes changing said parameter for:
a time delay to close said movable barrier;
an overlap delay to open said movable barrier; and
obstruction sensor sensitivity of said movable barrier operator.

16. The system of claim 15 wherein said controlling by said command center includes transmitting said task signal for:
opening said movable barrier;
closing said movable barrier;
stopping any movement of said movable barrier; and
simulating different sensor events in said movable barrier operator for troubleshooting purposes.

17. The system of claim 12 wherein said command center is also for upgrading a program of said movable barrier operator when said module derives said control signal from said task signal sent via said satellite system from said command center.

18. The system of claim 17 wherein said upgrading by said command center includes replacement of firmware of said program in order to make said movable barrier operator up-to-date.

19. The system of claim 18 wherein upgrading said program of said movable barrier operator includes replacement of said program from said command center on an individual basis and at multiple locations.

20. The system of claim 19 wherein upgrading said program of said movable barrier operator includes replacement of said program by:
a type of access control;
a customer; and
a distributor.

21. An access control system for simultaneous communication with and between a plurality of movable barrier operators that control a plurality of movable barriers via a satellite comprising:
a first module configured to communicate with a first movable barrier operator and a command center via said satellite;
a second module configured to communicate with a second movable barrier operator and said command center via said satellite;
wherein said command center transmits a task signal to said first and second modules via said satellite system, and said first and second modules receive said task signal and derive a control signal from said task signal; and
wherein said first and second modules transmit said control signal to said plurality of movable barrier operators to perform a task at said plurality of movable barriers.

22. The access control system of claim 21 wherein said task comprises upgrading a firmware installed at said movable barrier operator.

23. The access control system of claim 22 wherein said task comprises adjusting a parameter of said movable barrier operator.

24. An access control system for communicating with a movable barrier operator utilizing a satellite system, comprising:
a command center for communicating via said satellite system to said movable barrier operator; and
a movable barrier operator connected to a movable barrier,
wherein said movable barrier operator is configured for telemetry communication with said command center, and
wherein said command center monitors a status of said movable barrier operator when said command center receives a signal sent from said movable barrier operator via said satellite system.

25. An access control system for communicating with a movable barrier operator utilizing a satellite system, comprising:
a module configured for telemetry communication with a command center;
a movable barrier operator connected to said module;
wherein said command center is for:
receiving a task signal via said satellite system from said module; and
transmitting a control signal derived from said task signal to said module via said satellite system;
wherein said module is for:
sending said first signal via said satellite system to said command center;
deriving a control signal from said second signal from said command center; and
transmitting said control signal to said movable barrier operator; and wherein said command center is also for:
monitoring a status of said movable barrier operator when said command center receives said first signal sent via said satellite system from said module;
adjusting a parameter of said movable barrier operator when said module derives said control signal from said second signal sent via said satellite system from said command center;
controlling a function of said movable barrier operator when said module transmits said control signal to said movable barrier operator; and
upgrading a program of said movable barrier operator when said module derives said control signal from said second signal via said satellite system from said command center; and wherein said command center is also for:
upgrading said program of said movable barrier operator, which includes replacement of said program from said command center on an individual basis and at multiple locations where there are movable barrier operators within a region, a country, and on a global level.
